(19) United States
(12) Patent Application Publication
(10) Pub. No.: US 2009/0233177 A1
(43) Pub. Date: Sep. 17, 2009

(54) NONAQUEOUS ELECTROLYTE SECONDARY BATTERY

(76) Inventors: Hideaki Fujita, Osaka (JP); Masatoshi Nagayama, Osaka (JP); Kiyomi Kozuki, Osaka (JP)

Correspondence Address: MCDERMOTT WILL & EMERY LLP, 600 13TH STREET, NW, WASHINGTON, DC, 20005-3096, US

(21) Appl. No.: 12/065,798

(22) PCT Filed: Jun. 14, 2007
(86) PCT No.: PCT/JP2007/061985

§ 371 Date: Mar. 5, 2008

(30) Foreign Application Priority Data
Jun. 16, 2006 (JP) 2006-167203

(51) Int. Cl. H01M 4/02

(52) U.S. Cl. 429/246

(57) ABSTRACT

One width end of an electrode of a nonaqueous electrolyte secondary battery is provided with an exposed portion. A reinforcing element for reinforcing the exposed portion is provided between adjacent parts of the exposed portion when seen in the longitudinal cross section of the battery.

### TECHNICAL FIELD

The present invention relates to aqueous electrolyte secondary batteries each having a tabless current-collecting structure, and more particularly relates to a nonaqueous electrolyte secondary battery that can form a tabless current-collecting structure with stability.

### BACKGROUND ART

Nonaqueous electrolyte secondary batteries (more specifically, lithium ion secondary batteries) each include an electrode group serving as an electric power generating element, a nonaqueous electrolyte, and a current collecting part and are used as power supplies for mobile phones, notebook computers, or other devices. An electrode group is configured such that a positive electrode and a negative electrode are wound or stacked with a separator interposed therebetween. A nonaqueous electrolyte is retained in the separator of the electrode group and holes in an electrode plate (e.g., holes in a mixture layer).

Shown in FIG. 9 is a current-collecting structure of such a nonaqueous electrolyte secondary battery.

As shown in FIG. 9, a positive electrode and a negative electrode each have a portion configured such that the surface of a current collector is provided with a mixture layer 1 and a portion (exposed portion) 2 at which the current collector is exposed without being provided with a mixture layer. This exposed portion 2 is located in a longitudinal end part or middle part of each of the positive electrode and the negative electrode and joined with a current collecting lead 3 (in many cases, leads made of aluminum are used for positive electrodes while leads made of nickel are used for negative electrodes). When such electrodes form an electrode group, current is collected along the longitudinal direction of each electrode (laterally in FIG. 9).

In a case where a nonaqueous electrolyte secondary battery is fabricated using the electrode shown in FIG. 9, the following steps are carried out: The positive electrode and the negative electrode are wound with a separator interposed therebetween; an electrode group is contained in a case, for example, with the current collecting lead of the positive electrode located above the current collecting lead of the negative electrode; and the current collecting lead of the negative electrode is joined to the case while the current collecting lead of the positive electrode is joined to a sealing plate.

For lithium ion secondary batteries, negative electrodes are generally wider than positive electrodes. Therefore, the deviation of an electrode plate caused by vibration or shock might cause a short circuit at an end surface of an electrode group. To cope with this, in Patent Document 1, in a lithium ion secondary battery having an electrode group configured such that a positive electrode and a negative electrode are stacked or wound, a porous layer composed of insulative particles and a binder is formed on the surface of the negative electrode, and further the end surfaces of the electrode group are protected by an insulator. This can suppress the deviation of the electrode plate caused by vibration and shock and prevent a short circuit.

Meanwhile, in the use of the electrode shown in FIG. 9, current is collected from a current collecting lead along the longitudinal direction of an electrode plate. This may cause high resistance during the current collection (current collection resistance). As a result, it may be difficult to obtain high power. In order to reduce the current collection resistance, a so-called “tabless structure” has been suggested. For the tabless structure, one width end of a current collector for each of a positive electrode and a negative electrode is formed with an exposed portion, and the portion of the current collector other than the exposed portion is formed with mixture layers. The positive and negative electrodes are placed such that the respective exposed portions of the positive and negative electrodes extend along mutually opposite directions and wound with a separator interposed therebetween, thereby forming an electrode group. Current collecting plates are welded to both end surfaces of the electrode group. The use of the tabless structure as described above increases the number of the junction points between the electrode group and the current collecting plates as compared with the use of the electrode shown in FIG. 9. Furthermore, unlike the use of the electrode shown in FIG. 9, current is collected along the width of an electrode plate. Thus, the use of the tabless structure can sharply reduce the current collection resistance as compared with the use of the electrode shown in FIG. 9.

However, for the tabless structure, on condition that the current collecting plates are joined to the electrode group, if the current collecting plate is welded thereto without being pressed against both end surfaces of the electrode group, the weld strength between each current collecting plate and the electrode group cannot be sufficiently increased. This may cause a poor weld. To cope with this, in Patent Document 2, each of current collecting plates is formed with a projection part, and an exposed portion is bent by pressing the projection part against the associated end surface of the electrode group. As a result, the exposed portion is formed partially with a flat part. Thus, the projection part of the current collecting plate and the flat part of the exposed portion are welded to each other while being in contact with each other. In this way, the current collecting plate and the electrode group can be welded to each other while being in contact with each other.

Patent Document 3 discloses a method in which an exposed portion of an electrode group is formed partially with a flat part, and more specifically discloses a method in which a certain jig is pressed against an end surface of the exposed portion while the electrode group is rotated around a winding spindle for the electrode group.

### Patent Document 1: Japanese Unexamined Patent Application Publication No. 2005-190912

### Patent Document 2: Japanese Unexamined Patent Application Publication No. 2000-294222

### Patent Document 3: Japanese Unexamined Patent Application Publication No. 2003-162995

### DISCLOSURE OF THE INVENTION

### Problems that the Invention is to Solve

In Patent Document 1, as shown in FIG. 1 of this document, at the end surfaces of an electrode group, the end surfaces of positive and negative electrodes are covered with insulators. Therefore, current is considered to be collected through a current collecting lead. When, as described above, current is collected through the current collecting lead, current is collected along the longitudinal direction of the electrodes, leading to an increase in the current collection resistance. As a result, it is difficult to increase the power of a nonaqueous electrolyte secondary battery. Therefore, it is considered as follows: It is difficult to use the nonaqueous electrolyte secondary battery disclosed in Patent Document 1 as a power supply of an electronic device requiring high power (e.g., power tools or hybrid vehicles).

Furthermore, in Patent Document 1, insulators are formed using an immersion method. Meanwhile, the electrode group in this document is not provided with a means for blocking the outflow of a solution of an insulator. Therefore, when the electrode group is moved before the solidification of the solution of the insulator, the solution of the insulator may flow out of the end surfaces of the electrode group. As a result, the fabrication process for a nonaqueous electrolyte secondary battery cannot proceed to the next step until the solidification of the solution of the insulator. This lengthens the fabrication time of the nonaqueous electrolyte secondary battery.

Moreover, a thin foil having a thickness smaller than or equal to approximately several tens of μm is used as a current collector for a lithium ion secondary battery. Therefore, in the technology disclosed in Patent Document 2, when the current collecting plate is pressed against the exposed portion, a part of the exposed portion in the vicinity of the root thereof may buckle. The buckling of the exposed portion may cause damage to a separator. This facilitates causing an internal short circuit. Furthermore, the buckling of the exposed portion causes a part of the exposed portion welded to the current collecting plate to approach a mixture layer. This approach facilitates the penetration of spatters produced in welding into the inside of the electrode group. This facilitates causing an internal short circuit. Even when a flat part of the exposed portion is formed using the technology disclosed in Patent Document 3, an internal short circuit is likely to be caused.

The present invention has been made in view of the above-described problems, and its object is to provide a nonaqueous electrolyte secondary battery that can increase the power of the battery, restrain the cause of occurrence of an internal short circuit from being produced during the fabrication of the battery and further prevent the fabrication time of the battery from being lengthened.

### Means of Solving the Problems

A nonaqueous electrolyte secondary battery of the present invention includes an electrode group in which a positive electrode and a negative electrode are wound or stacked with a separator interposed therebetween; a nonaqueous electrolyte retained in the separator; and a current collecting plate joined to the electrode group. One width end of one of the positive and negative electrodes is provided with an exposed portion in which a current collector is exposed from a mixture layer. In the electrode group, the exposed portion extends beyond an associated end surface of the separator and an associated end surface of the other electrode along the width of each said electrode, and the current collecting plate is joined to the end surface of the exposed portion. A reinforcing element for reinforcing the exposed portion is formed between adjacent parts of the exposed portion.

With the above-mentioned structure, current is collected along the width of each electrode. This can reduce the current collection resistance.

The above-mentioned structure allows the exposed portion to be reinforced. This can restrain the exposed portion from being bent during the fabrication of the battery.

Furthermore, even when the reinforcing element is formed in the manner in which a solution for the reinforcing element is applied to a predetermined location and then the applied solution for the reinforcing element is dried or cooled, the solution for the reinforcing element can be retained between adjacent parts of the exposed portion.

Herein, “adjacent” means that in a case where a positive electrode and a negative electrode are wound, the winding of the electrodes allows a part of the exposed portion corresponding to the n-th turn thereof and a part thereof corresponding to the (n+1)-th turn thereof to be adjacent to each other and means that in a case where positive electrodes and negative electrodes are stacked, an exposed portion of the n-th positive electrode and an exposed portion of the (n+1)-th positive electrode are adjacent to each other.

In the nonaqueous electrolyte secondary battery of the present invention, the reinforcing element may cover an associated end surface of the mixture layer of said one electrode, the associated end surface of the separator and the associated end surface of the other electrode. In this case, the reinforcing element may be formed such that a part of the reinforcing element covering the associated end surface of the other electrode becomes thinner than or flush with a part of the reinforcing element covering the associated end surface of the mixture layer of said one electrode. Furthermore, the reinforcing member may cover only the associated end surface of the mixture layer of said one electrode.

As described above, the location at which the reinforcing element is formed is not particularly limited. On condition that an area of the end surface of the electrode group provided with the reinforcing element is large or that the reinforcing element is thick, this can restrain an unnecessary substance or the like from penetrating into the inside of the electrode group during the fabrication of the battery. As a result, the breakage of the separator can be suppressed, thereby reducing the probability of occurrence of a short circuit. On the other hand, on condition that the area of the end surface of the electrode group provided with the reinforcing element is small or that the reinforcing element is thin, if a nonaqueous electrolytic solution containing a solute and a nonaqueous solvent is used as the nonaqueous electrolyte, the liquid permeability of the nonaqueous electrolytic solution into the inside of the electrode group can be improved.

### EFFECTS OF THE INVENTION

The present invention can increase the power of a battery, restrain the cause of occurrence of an internal short circuit from being produced during the fabrication of the battery and furthermore prevent the fabrication time of the battery from being lengthened.

### BRIEF DESCRIPTION OF DRAWINGS

FIG. 1(a) is a perspective view of an electrode group according to a first embodiment of the present invention, and FIG. 1(b) is a longitudinal cross-sectional view of an IB area shown in FIG. 1(a).

FIG. 2 is a plan view of each of a positive electrode and a negative electrode of the present invention.

FIG. 3(a) is a plan view of a current collecting plate, and FIG. 3(b) is a cross-sectional view of the current collecting plate shown in FIG. 3(a).

FIG. 4(a) is a plan view of another current collecting plate, and FIG. 4(b) is a cross-sectional view of the current collecting plate shown in FIG. 4(a).

FIG. 5 is a longitudinal cross-sectional view showing a current collecting structure according to the first embodiment of the present invention.

FIG. 6 is a longitudinal cross-sectional view showing a current collecting structure according to a second embodiment of the present invention.

FIG. 7 is a longitudinal cross-sectional view showing a current collecting structure according to a third embodiment of the present invention.

FIG. 8 is a longitudinal cross-sectional view showing a current collecting structure according to a fourth embodiment of the present invention.

FIG. 9 is a plan view of each of a known positive electrode and a known negative electrode.

FIGS. 10(a) and 10(b) are longitudinal cross-sectional views showing the structure of a lithium ion secondary battery disclosed in Patent Document 1 when the battery is provided with a reinforcing element.

### DESCRIPTION OF REFERENCE NUMERALS

5 current collector
6 mixture layer
6a end surface
7 exposed portion
8 positive electrode
8a end surface
9 current collector
10 mixture layer
10a end surface
11 exposed portion
12 negative electrode
12a end surface
13 separator
14, 24, 34, 44 electrode group
15 reinforcing element
19, 29 current collecting plate

### BEST MODE FOR CARRYING OUT THE INVENTION

Embodiments of the present invention will be described hereinafter in detail with reference to the drawings. In the following embodiments, a lithium ion secondary battery configured such that a nonaqueous electrolytic solution containing a solute (e.g., lithium salt) and a nonaqueous solvent is retained at least in a separator is used as an exemplary nonaqueous electrolyte secondary battery. In the following embodiments, substantially the same components are denoted by the same reference numerals, and in some cases, the description thereof is not given.

### Embodiment 1 of the Invention

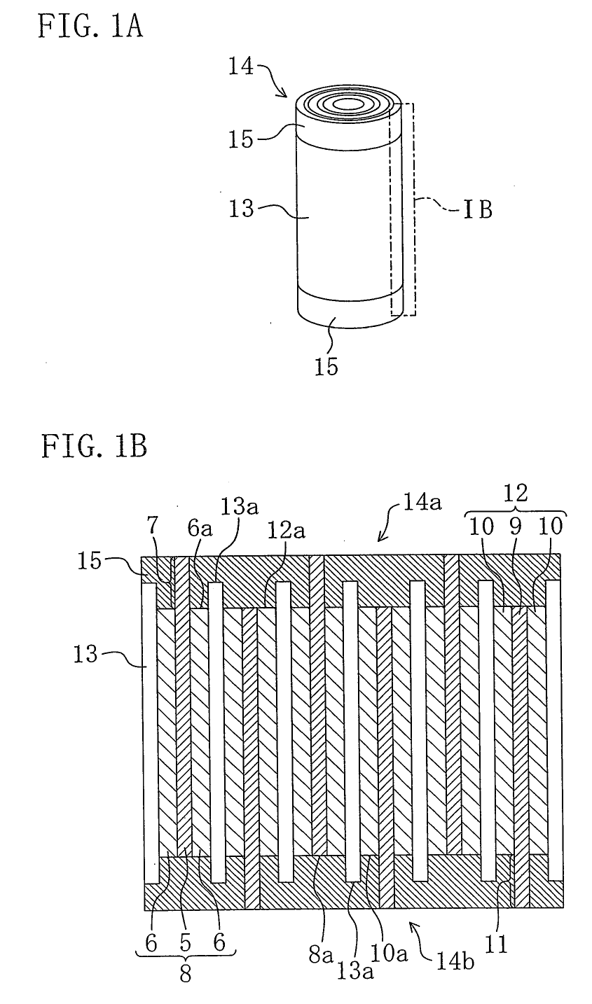

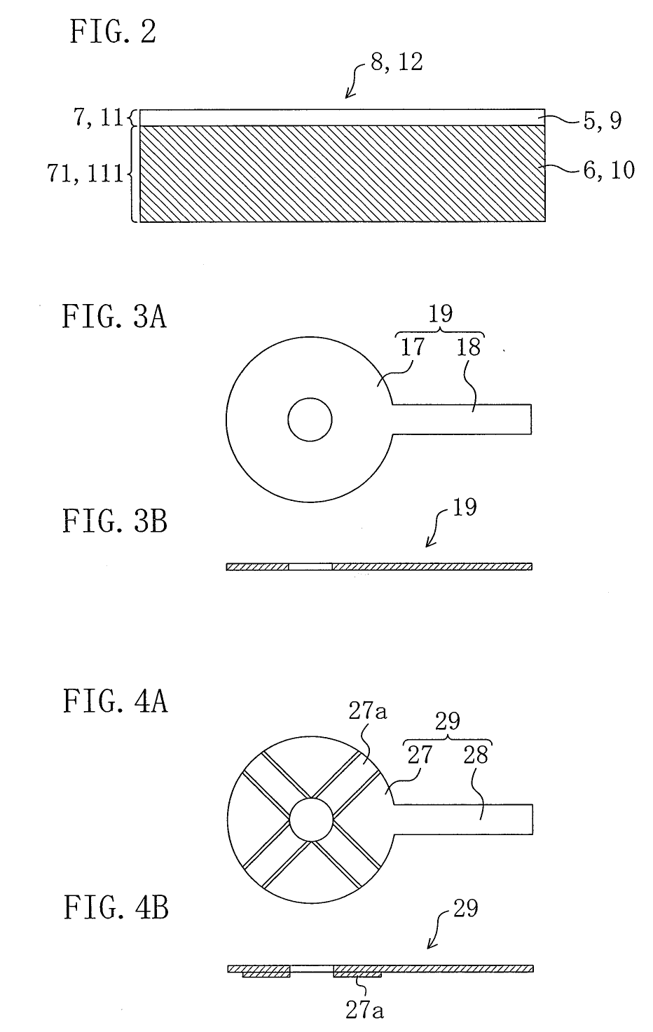

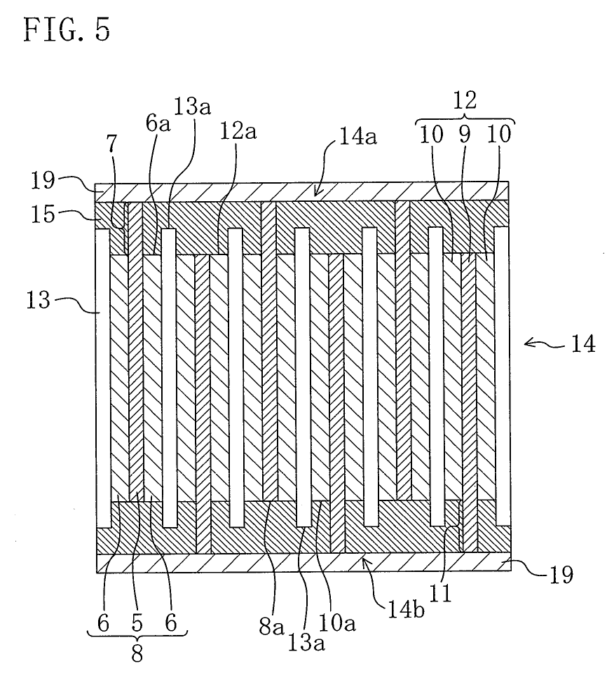

FIGS. 1(a) and 1(b) show the structure of an electrode group according to a first embodiment. FIG. 1(a) is a perspective view of the electrode group, and FIG. 1(b) is a longitudinal cross-sectional view of a region IB thereof shown in FIG. 1(a). FIG. 2 is a plan view showing the structure of each of positive and negative electrodes. FIGS. 3(a) and 3(b) show the structure of a current collecting plate. FIG. 3(a) is a plan view of the current collecting plate, and FIG. 3(b) is a cross-sectional view thereof. FIGS. 4(a) and 4(b) show another current collecting plate. FIG. 4(a) is a plan view of another current collecting plate, and FIG. 4(b) is a cross-sectional view thereof. FIG. 5 is a longitudinal cross-sectional view showing a part of a current collecting structure according to this embodiment.

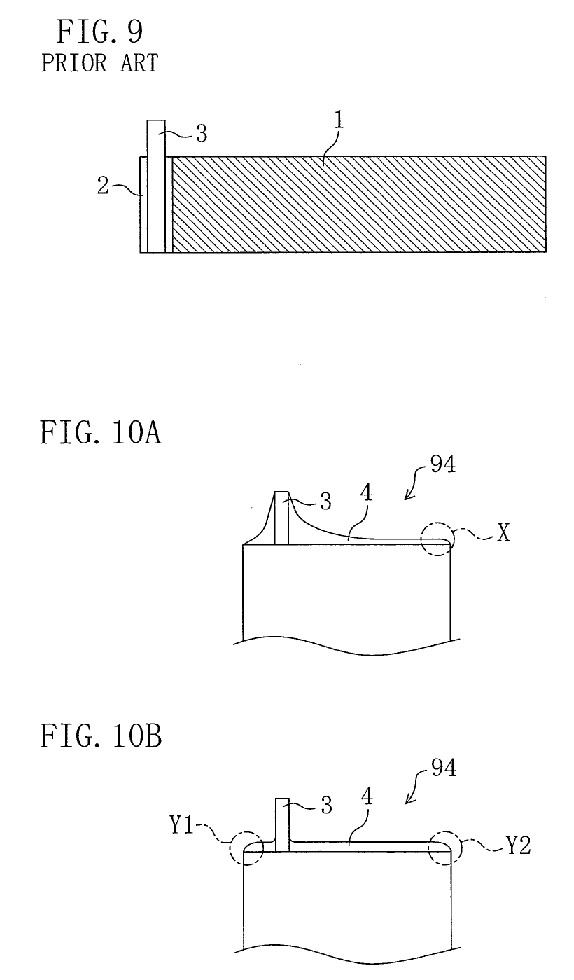

The lithium ion secondary battery according to this embodiment represents a secondary battery of a tabless current-collecting structure including an electrode group 14, a nonaqueous electrolytic solution (not shown) and current collecting plates 19. For the electrode group of the secondary battery of the tabless current-collecting structure, one width end of a positive electrode 8 (one vertical end thereof in FIG. 2) is provided with an exposed portion 7, and one width end of a negative electrode 12 is provided with an exposed portion 11. This allows current to be collected along the width of each electrode. This can reduce the current collection resistance of the lithium ion secondary battery according to this embodiment as compared with the case shown in FIG. 9 and increase the power of the lithium ion secondary battery.

For the positive electrode 8, its exposed portion 7 is formed by partially exposing a current collector 5 so as to be prevented from being provided with a mixture layer 6, and the portion 71 of the current collector 5 other than the exposed portion 7 is provided with mixture layers 6. Likewise, for the negative electrode 12, its exposed portion 11 is formed by partially exposing a current collector 9 so as to be prevented from being provided with a mixture layer 10, and the portion 111 of the current collector 9 other than the exposed portion 11 is provided with mixture layers 10.

For the electrode group 14 of this embodiment, the positive electrode 8 and the negative electrode 12 are wound with a separator 13 interposed therebetween, and the exposed portion 7 of the positive electrode 8 and the exposed portion 11 of the negative electrode 12 extend beyond the end surfaces of the separator in mutually opposite directions. A current collecting plate 19 for the positive electrode is joined to the end surface of the exposed portion 7 of the positive electrode 8 while a current collecting plate 19 for the negative electrode is joined to the end surface of the exposed portion 11 of the negative electrode 12. Furthermore, a nonaqueous electrolytic solution is retained in the electrode group 14 (in particular, the separator 13).

Each of the current collecting plates 19 will be described briefly. As shown in FIGS. 3(a) and 3(b), the current collecting plate 19 includes a circular portion 17 and a tab portion 18. The tab portion 18 is continuous with the circular portion 17, and the end surface of the associated exposed portion is joined to the circular portion 17. A current collecting plate 29 shown in FIGS. 4(a) and 4(b) may be used instead. Like the current collecting plate 19, the current collecting plate 29 includes a circular portion 27 and a tab portion 28. Meanwhile, projection members 27a are radially disposed on the circular portion 27. The end surface of the exposed portion is joined to the projection members 27a.

In a case where the current collecting plate 19 or 29 is joined to the exposed portion 7 of the positive electrode 8, the current collecting plate 19 or 29 is preferably made of aluminum. In a case where the current collecting plate 19 or 29 is joined to the exposed portion 11 of the negative electrode 12, the current collecting plate 19 or 29 is preferably made of nickel or copper.

The electrode group 14 will be described hereinafter in detail.

For one end 14a (the upper end in FIG. 1(b)) of the electrode group 14, the exposed portion 7 of the positive electrode 8 extends beyond the associated end surface 12a of the negative electrode 12 along the width of each electrode. Since, in the electrode group 14, the positive electrode 8 is wound, a part of the exposed portion 7 of the positive electrode 8 corresponding to the n-th turn thereof and a part thereof corresponding to the (n+1)-th turn thereof are adjacent to each other when viewed in the longitudinal cross section of the electrode group 14. A reinforcing element 15 is disposed between the part of the exposed portion 7 of the positive electrode 8 corresponding to the n-th turn thereof and the part thereof corresponding to the (n+1)-th turn thereof.

The reinforcing element 15 is disposed at the end 14a of the electrode group 14 to be flush with the end surface of the exposed portion 7 of the positive electrode 8 and covers the associated end surfaces 6a of the mixture layers 6 of the positive electrode 8, the associated end surface 13a of the separator 13 and the associated end surface 12a of the negative electrode 12 while the end surface of the exposed portion 7 of the positive electrode 8 is exposed. Therefore, when the end 14a of the electrode group 14 is seen from above, the end surface of the exposed portion 7 of the positive electrode 8 is swirled, and space in the swirl is filled with the reinforcing element 15.

Likewise, for the other end 14b (the lower end in FIG. 1(b)) of the electrode group 14, the exposed portion 11 of the negative electrode 12 extends beyond the associated end surface 8a of the positive electrode 8 along the width of each electrode. Since, in the electrode group 14, the negative electrode 12 is wound, a part of the exposed portion 11 of the negative electrode 12 corresponding to the n-th turn thereof and a part thereof corresponding to the (n+1)-th turn thereof are adjacent to each other when viewed in the longitudinal cross-section of the electrode group 14. Another reinforcing element 15 is disposed between the part of the exposed portion 11 of the negative electrode 12 corresponding to the n-the turn thereof and the part thereof corresponding to the (n+1)-th turn thereof.

The reinforcing element 15 is disposed at the other end 14b of the electrode group 14 to be flush with the end surface of the exposed portion 11 of the negative electrode 12 and covers the associated end surfaces 10a of the mixture layers 10 of the negative electrode 12, the associated end surface 13a of the separator 13 and the associated end surface 6a of the positive electrode 6 with the end surface of the exposed portion 11 of the negative electrode 12 exposed. Therefore, when the other end of the electrode group 14 is seen from above, the end surface of the exposed portion 11 of the negative electrode 12 is swirled, and space in the swirl is filled with the reinforcing element 15.

A material of the reinforcing elements 15 is not limited. However, a material exhibiting excellent insulation performance and excellent liquid permeability is preferably selected as the material of the reinforcing elements 15. The reasons for this will be described hereinafter.

If a material with excellent conductivity were selected as a material of reinforcing elements, a short circuit may be caused between a positive electrode and a negative electrode. However, when a material with excellent insulation performance is selected as the material of the reinforcing elements 15, this can restrain the occurrence of the short circuit.

The lithium ion secondary battery is configured such that a nonaqueous electrolytic solution penetrates through the end surface 8a of the positive electrode 8, the end surfaces 13a of the separator 13 and the end surface 12a of the negative electrode 12 into the inside of the electrode group 14. Therefore, if a material with poor liquid permeability were selected as a material of reinforcing elements, the reinforcing elements may block the penetration of a nonaqueous electrolytic solution into the inside of an electrode group. As a result, an electrode reaction may be suppressed. However, when a material with excellent liquid permeability is selected as the material of the reinforcing elements 15, the nonaqueous electrolytic solution penetrates into the inside of the electrode group 14 even with the reinforcing elements 15 covering the end surface 8a of the positive electrode 8, the end surfaces 13a of the separator 13 and the end surface 12a of the negative electrode 12. As a result, an electrode reaction can be advanced.

More specifically, a porous insulative material is preferably used as the reinforcing elements 15. The reason for this is that when a porous material is used as the reinforcing elements 15, the nonaqueous electrolytic solution is supplied through holes in the reinforcing elements 15 to the inside of the electrode group 14. More specifically, a material of the reinforcing elements 15 may be a binder for a positive electrode or a binder for a negative electrode. Alternatively, it may be a porous film containing insulative particles and a binder.

Fluorine resins, such as PTFE (polytetrafluoroethylene) or PVDF (polyVinylidine difluoride), can be used as a binder for a positive electrode. SBR (styrene-butadiene rubber) and rubber particles made of a styrene-butadiene copolymer (SBR) can be used as a binder for a negative electrode.

An electrochemically stable material having excellent heat resistance is preferably selected as the insulative particles for the porous film. An inorganic oxide, such as alumina, or the like can be selected. The binder is provided to fix the insulative particles in the porous film. An amorphous material having excellent heat resistance is preferably selected as the binder. A rubberlike polymer containing the polyacrylonitrile group or other materials can be used.

Each reinforcing element 15 may contain a solidified nonaqueous solvent. The reason for this is that when the use of the lithium ion secondary battery or any other factor increases the temperature of the inside of the lithium ion secondary battery, the nonaqueous solvent flows out of the reinforcing element 15 and is supplied to the inside of the electrode group 14. Therefore, with an increase in the time during which the lithium ion secondary battery is used, the volume of the reinforcing element 15 is reduced. Ethylene carbonate (EC) is often used as the nonaqueous solvent. Therefore, an element made of EC is preferably used as the reinforcing element 15.

The electrode group 14 is preferably provided with such reinforcing elements 15 in the following method. First, a solution for reinforcing elements is prepared by dissolving the reinforcing elements 15 in an appropriate solvent. Next, the prepared solution for reinforcing elements is applied to the end surfaces of the electrode group 14, and then the applied solution for reinforcing elements is dried or solidified. Methods for applying the solution for reinforcing elements to the end surfaces of the electrode group 14 can include an immersion method and an injection method.

The lithium ion secondary battery of this embodiment will be described hereinafter while the lithium ion secondary battery disclosed in Patent Document 1 is compared to the lithium ion secondary batteries disclosed in Patent Documents 2 and 3.

In Patent Document 1, as shown in FIG. 1 of this document, the end surfaces of positive and negative electrodes are covered with insulators. Therefore, it is considered that current cannot be collected even with current collecting plates joined to these end surfaces. Consequently, current is considered to be collected through current collecting leads.

The lithium ion secondary batteries disclosed in Patent Documents 2 and 3 each have a tabless current-collecting structure but each include no reinforcing element.

First, the lithium ion secondary battery disclosed in Patent Document 1 will be described.

It is estimated that, as described above, the lithium ion secondary battery disclosed in Patent Document 1 does not have a tabless current-collecting structure. Therefore, as shown in FIGS. 10(a) and 10(b), one current collecting lead 3 simply extends from one end surface of an electrode group 94 (the other current collecting lead extends from the lower surface of the electrode group 94). On condition that one end surface of such an electrode group 94 is provided with an insulator, if the end surface of the electrode group 94 is immersed in a solution for an insulator, a film 4 of the solution for an insulator is formed so that the distal end of the current collecting lead is connected to one point on the end surface of the electrode group as shown in FIG. 10(a). As a result, as shown in FIG. 10(a), while a sufficient amount of the solution for an insulator can be applied around the current collecting lead 3, the amount of the applied solution for an insulator is reduced with an increase in the distance from the current collecting lead 3. In some cases, the solution for an insulator is not applied to an edge part (the region X shown in FIG. 10(a)) of the end surface of the electrode group 94. Furthermore, the movement of the electrode group 94 may cause the solution for an insulator to flow out of the end surface of the electrode group 94. Accordingly, the electrode group 94 must be left at rest until the solidification of the solution for an insulator.

On the other hand, on condition that the end surface of the electrode group 94 is provided with the insulator, if the solution for an insulator is injected onto the end surface of the electrode group 94, the solution for an insulator can be uniformly spread over the end surface of the electrode group 94. However, even in the use of the injection method, the movement of the electrode group may cause the solution for an insulator to flow out of the end surface (more specifically, the regions Y1 and Y2 shown in FIG. 10(b)) of the electrode group 94 and slip down the side surfaces of the electrode group 94. Accordingly, the electrode group 94 must be left at rest until the solidification of the solution for an insulator.

Next, the lithium ion secondary batteries disclosed in Patent Documents 2 and 3 will be described.

The lithium ion secondary batteries disclosed in Patent Documents 2 and 3 do not include the above-described reinforcing elements. In this case, an exposed portion of each of electrodes is as thick as a current collector (more specifically, both of the exposed portion and the current collector have a thickness of several tens of μm or less). Therefore, when an external force is applied to the exposed portion (e.g., when a current collecting plate is pressed against an electrode group to join the current collecting plate to one end surface of the electrode group), the exposed portion may be bent. This reduces the production yield of lithium ion secondary batteries. Furthermore, when the exposed portion is bent and thus comes into contact with an electrode plate of the opposite polarity or when the exposed portion is bent and thus a separator is broken, this facilitates causing an internal short circuit.

For the lithium ion secondary battery disclosed in each of Patent Documents 2 and 3, the end surfaces of a positive electrode, a separator and a negative electrode are exposed during the fabrication process for the battery. Even after a current collecting plate is bonded to the end surface of each exposed portion, space exists between the current collecting plate and the separator or any other component. For this reason, during the fabrication process for the lithium ion secondary battery, an unnecessary substance (more specifically, spatters produced in welding or any other substance) may penetrate through the end surfaces of the positive electrode, the separator and the negative electrode into the inside of the electrode group. The penetrating unnecessary substance may break the separator. The breakage of the separator facilitates causing an internal short circuit.

In view of the above, it is considered that the lithium ion secondary battery disclosed in Patent Document 1 does not have a tabless current-collecting structure. Therefore, the use of an immersion method makes it impossible to uniformly apply a solution for an insulator onto an end surface of an electrode group 94. Furthermore, even in the case of the use of either an immersion method or an injection method, the electrode group 94 must be left at rest until the dehydration or solidification of the solution for an insulator.

For the lithium ion secondary battery disclosed in each of Patent Documents 2 and 3, an exposed portion of each of electrodes may be bent during the fabrication process for the battery. Furthermore, an unnecessary substance may penetrate into the inside of an electrode group, leading to the broken separator.

However, when a solution for reinforcing elements is applied to the end surfaces of the electrode group 14 of this embodiment, the solution for reinforcing elements is retained between adjacent parts of an exposed portion 7 of the positive electrode 8 or between adjacent parts of an exposed portion 11 of the negative electrode 12. In other words, the exposed portion 7 of the positive electrode 8 and the exposed portion 11 of the negative electrode 12 restrain the solution for reinforcing elements from flowing out of the end surfaces of the electrode group 14. This eliminates the need for leaving the electrode group 14 at rest until the solidification of the solution for reinforcing elements.

In a case where the solution for reinforcing elements is applied to the end surfaces of the electrode group 14 using an immersion method, a film of the solution for reinforcing elements is formed to connect between the distal end of a part of the exposed portion 7 of the positive electrode 8 corresponding to the n-th turn thereof and the distal end of a part thereof corresponding to the (n+1)-th turn thereof, and another film of the solution for reinforcing elements is formed to connect between the distal end of a part of the exposed portion 11 of the negative electrode 12 corresponding to the n-th turn thereof and the distal end of a part thereof corresponding to the (n+1)-th turn thereof. With the structure of the electrode group 14 of this embodiment, the solution for reinforcing elements can be uniformly applied to the end surfaces of the electrode group 14.

Furthermore, for the lithium ion secondary battery of this embodiment, the provision of the reinforcing elements 15 allows the exposed portion 7 of the positive electrode 8 and the exposed portion 11 of the negative electrode 12 to be reinforced. This can restrain the exposed portion 7 of the positive electrode 8 from being bent even with an external force applied to the exposed portion 7 of the positive electrode 8 and restrain the exposed portion 11 of the negative electrode 12 from being bent even with an external force applied to the exposed portion 11 of the negative electrode 12. This restraint can prevent, for example, the exposed portion 7 of the positive electrode 8 from being in contact with the negative electrode 12 during the fabrication of the battery and prevent the separator 13 from being broken during the fabrication thereof. As a result, the probability of occurrence of an internal short circuit can be reduced.

In addition, since, for the lithium ion secondary battery of this embodiment, the reinforcing elements 15 cover the end surface 8a of the positive electrode 8, the end surfaces 13a of the separator 13 and the end surface 12a of the negative electrode 12, this can prevent an unnecessary substance or any other substance from penetrating into the inside of the electrode group 14 during the fabrication process for the battery. This prevention can prevent the separator 13 from being broken during the fabrication process for the battery. As a result, a lithium ion secondary battery with excellent quality can be fabricated.

Furthermore, when a material exhibiting excellent insulation performance and excellent liquid permeability is selected as a material of the reinforcing elements 15, this can restrain a reduction in the permeability of a nonaqueous electrolytic solution into the inside of the electrode group 14. When the solidified solvent of the nonaqueous electrolytic solution is used as the reinforcing elements 15, this also allows the exposed portion 7 of the positive electrode 8 and the exposed portion 11 of the negative electrode 12 to be reinforced. This reinforcement can prevent the exposed portion 7 of the positive electrode 8 and the exposed portion 11 of the negative electrode 12 from being bent under pressure from the current collecting plates 19 to the electrode group 14 and further prevent an unnecessary substance from penetrating into the inside of the electrode group 14 during the fabrication of the battery. Therefore, the above-mentioned effects can be provided even in the case where after the solvent of the nonaqueous electrolytic solution serving as the reinforcing elements 15 has penetrated into the inside of the electrode group 14 with use of the lithium ion secondary battery as described above, the reinforcing elements 15 are reduced in volume or completely lost.

In other words, the reinforcing elements 15 not only reinforce the exposed portion 7 of the positive electrode 8 and the exposed portion 11 of the negative electrode 12 but also function as shields for restraining an unnecessary substance from penetrating into the inside of the electrode group 14 during the fabrication of a lithium ion secondary battery. Meanwhile, the reinforcing elements 15 preferably allow a nonaqueous electrolytic solution to penetrate into the inside of the electrode group 14.

Next, a fabrication method for a lithium ion secondary battery according to this embodiment will be specifically described.

In order to fabricate the lithium ion secondary battery of this embodiment, a positive electrode 8 and a negative electrode 12 are initially produced.

In order to produce the positive electrode 8, an active material, a conductive agent and a binder are kneaded with water or an organic solvent by using a kneader, thereby preparing a slurry-like positive-electrode mixture.

In this case, a composite oxide, such as lithium cobaltate, a derivative of lithium cobaltate (e.g., a material produced by precipitating aluminum or magnesium out of lithium cobaltate), lithium nickelate, a derivative of lithium nickelate (a material obtained by replacing part of nickel with cobalt, aluminum or any other substance), lithium manganate, or a derivative of lithium manganate, is preferably used as the active material. Any one of acetylene black, ketjen black and various graphites or a combination of two or more thereof is preferably used as the conductive agent. Polytetrafluoroethylene (PTFE), polyvinylidene fluoride (PVDF), or any other material is preferably used as the binder. Furthermore, if necessary, a thickening agent may be charged into the kneader.

Next, the slurry-like positive-electrode mixture is applied onto a current collector 5 (for example, made of aluminum) for a positive electrode 8 using a die coating device or any other device and then dried, thereby forming mixture layers 6 for a positive electrode 8 on the current collector 5 for a positive electrode 8. Meanwhile, the slurry-like positive-electrode mixture is not applied onto one width end of the current collector 5 for a positive electrode 8. Thus, an exposed portion 7 of a positive electrode 8 is formed.

Subsequently, if necessary, an object obtained by forming mixture layers 6 for a positive electrode 8 on the current collector 5 for a positive electrode 8 is pressed and cut to the required size. Thus, a positive electrode 8 can be produced.

In order to produce a negative electrode 12, an active material and a binder are initially kneaded with water or an organic solvent by using a kneader, thereby preparing a slurry-like negative-electrode mixture.

In this case, any of various natural graphites, artificial graphites, an alloy composition material, and any other material is preferably used as the active material. Styrene-butadiene rubber (SBR), PVDF or any other material is preferably used as the binder. Furthermore, if necessary, a thickening agent may be charged into the kneader.

Next, the slurry-like negative-electrode mixture is applied onto a current collector 9 (for example, made of copper) for a negative electrode 12 using a die coating device or any other device and then dried, thereby forming mixture layers 10 for a negative electrode 12 on the current collector 9 for a negative electrode 12. Meanwhile, the slurry-like negative-electrode mixture is not applied onto one width end of the current collector 9 for a negative electrode 12. Thus, an exposed portion 11 of a negative electrode 12 is formed. Subsequently, if necessary, an object obtained by forming mixture layers 10 for a negative electrode 12 on the current collector 9 for a negative electrode 12 is pressed and cut to the required size. Thus, a negative electrode 12 can be produced.

After the production of the positive electrode 8 and the negative electrode 12, an electrode group 14 is produced. More specifically, the positive electrode 8 and the negative electrode 12 are disposed such that the exposed portion 7 of the positive electrode 8 and the exposed portion 11 of the negative electrode 12 extend along mutually opposite directions. Thereafter, the positive electrode 8 and the negative electrode 12 are wound with a separator 13 interposed therebetween such that the wound electrodes form a cylindrical shape or a box shape.

In this case, a microporous film which has high retention capability for a nonaqueous electrolytic solution and which is stable under the electrical potentials of both the positive electrode 6 and the negative electrode 8 is preferably used as the separator 13. For example, a material made of polypropylene, a material made of polyethylene, a material made of polyimide, a material made of polyamide, or any other material can be used as such a separator 13.

After the electrodes are wound, reinforcing elements 15 are provided using an immersion method. More specifically, a reinforcing element is dissolved or dispersed in an appropriate solvent, thereby preparing a solution for a reinforcing element. The solution for a reinforcing element is put into a container. Thereafter, the exposed portion 7 of the positive electrode 8 is immersed in the solution for a reinforcing element. After a fixed period of this immersion, the exposed portion 7 of the positive electrode 8 is raised from the solution for a reinforcing element. Subsequently, the solution for a reinforcing element adhered to the end surface of the exposed portion 7 of the positive electrode 8 is wiped off. In this way, while the end surface of the exposed portion 7 of the positive electrode 8 is exposed, space between adjacent parts of an exposed portion 7 is filled with the solution for a reinforcing element. Thereafter, an unnecessary solvent is removed from the solution for a reinforcing element by applying heat or the like to the solution for a reinforcing element. Alternatively, the solution for a reinforcing element may be cooled so as to be solidified.

When EC is selected as one exemplary material of the reinforcing elements 15, EC (with a melting point of 39° C.) is initially heated and molten. Next, the exposed portion 7 of the positive electrode 8 is immersed in liquid EC. Subsequently, EC adhered to the end surface of the exposed portion 7 of the positive electrode 8 is wiped off and then cooled.

When a porous binder is selected as another exemplary material of the reinforcing elements 15, the binder is initially dispersed or dissolved in water or an organic solvent, thereby preparing a solution. Next, the exposed portion 7 of the positive electrode 8 is immersed in the solution, and then an unnecessary solvent is removed.

When a porous film containing insulative particles and a binder is selected as still another exemplary material of the reinforcing elements 15, the insulative particles and the binder are initially charged into the kneader and kneaded with an appropriate solvent, thereby producing slurry. Next, the exposed portion 7 of the positive electrode 8 is immersed in this slurry, and then an unnecessary solvent is removed.

In the similar manner, the exposed portion 11 of the negative electrode 12 is also provided with the other one of the reinforcing elements 15.

Thereafter, current collecting plates 19, 19 are joined to the end surface of the exposed portion 7 of the positive electrode 8 and that of the exposed portion 11 of the negative electrode 12, respectively, by using a known welding method, such as a resistance welding method or a laser welding method. In this way, the current collecting structure shown in FIG. 5 is produced.

The electrode group shown in FIG. 5 is contained in a case, and a nonaqueous electrolytic solution is injected into the case. Thereafter, necessary parts of the case are sealed, thereby fabricating a lithium ion secondary battery.

### Embodiment 2 of the Invention

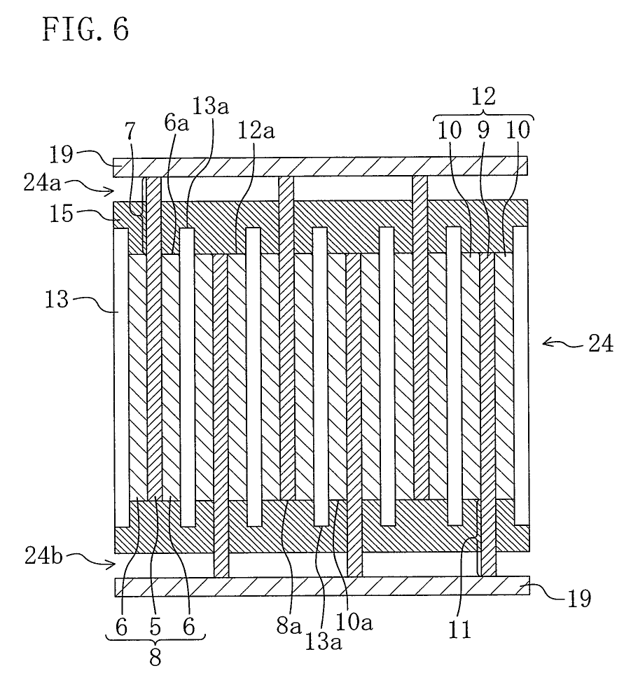

FIG. 6 is a longitudinal cross-sectional view showing the configuration of a current collecting structure according to a second embodiment.

At one end 24a of an electrode group 24 of this embodiment, an exposed portion 7 of a positive electrode 8 extends beyond the surface of an associated reinforcing element 15 along the width of the electrode. At the other end 24b of the electrode group 24, an exposed portion 11 of a negative electrode 12 extends beyond the surface of another reinforcing element 15 along the width of the electrode. Even with this configuration, substantially the same effect as in the first embodiment can be provided.

A method for producing a reinforcing element taking the form shown in FIG. 6 is not particularly limited. However, if a material of the reinforcing elements 15 has heat shrinkability, the configuration shown in FIG. 6 may be provided.

### Embodiment 3 of the Invention

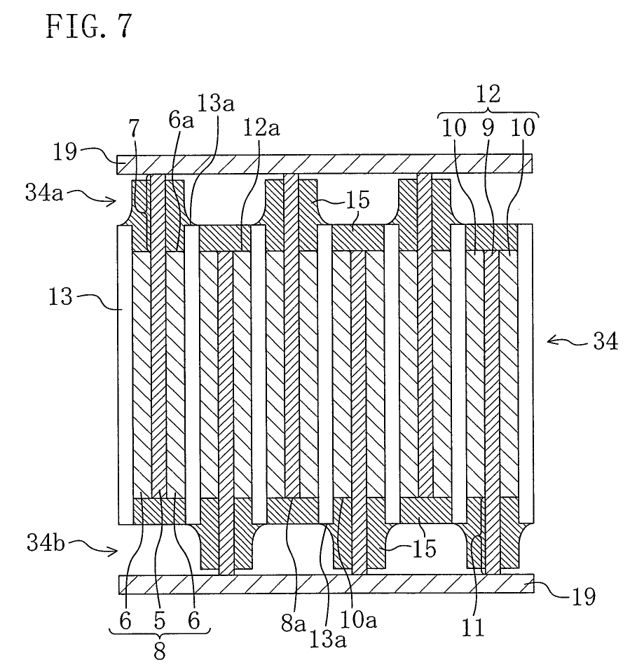

FIG. 7 is a longitudinal cross-sectional view showing the configuration of a current collecting structure according to a third embodiment.

In this embodiment, like the first embodiment, reinforcing elements 15 cover an end surface 8a of a positive electrode 8, the end surfaces 13a of a separator 13 and an end surface 12a of a negative electrode 12. However, as shown in FIG. 7, at one end 34a of an electrode group 34, a part of one of the reinforcing elements 15 covering the end surface 12a of the negative electrode 12 is thinner than a part thereof covering an associated end surface 6a of each of mixture layers 6 of the positive electrode 8. At the other end 34b of the electrode group 34, a part of the other one of the reinforcing elements 15 covering the end surface 8a of the positive electrode 8 is thinner than a part thereof covering an associated end surface 10a of each of mixture layers 10 of the negative electrode 12.

Even with this configuration, substantially the same effect as in the first embodiment can be provided. Furthermore, since, with the configuration shown in FIG. 7, each reinforcing element 15 is partially thinner than that in the first embodiment, it has excellent liquid permeability as compared with the case of the first embodiment.

### Embodiment 4 of the Invention

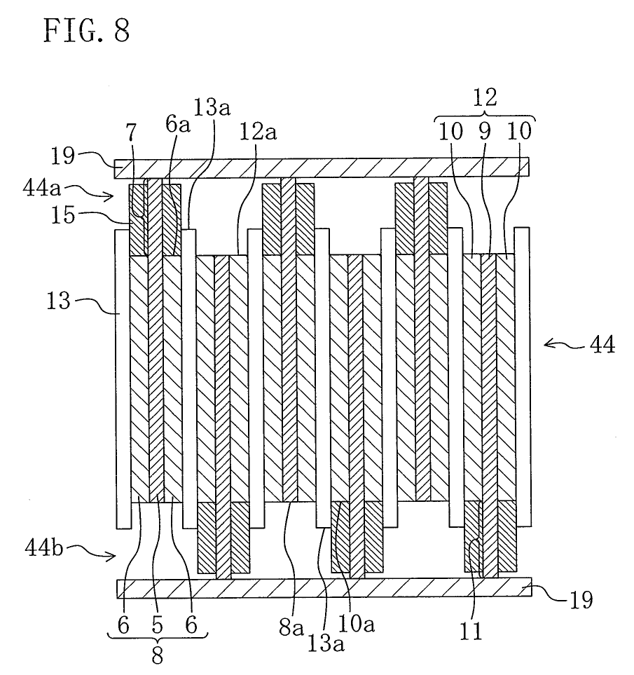

FIG. 8 is a longitudinal cross-sectional view showing the configuration of a current collecting structure according to a fourth embodiment.

In this embodiment, as shown in FIG. 8, reinforcing elements 15 cover, at one end 44a of an electrode group 44, only the end surfaces 6a of mixture layers 6 of a positive electrode 8 and, at the other end 44b of the electrode group 44, only the end surfaces 10a of mixture layers 10 of a negative electrode 12.

With this configuration, since parts of the ends 44a and 44b of the electrode group 44 are not provided with the reinforcing elements 15, this causes the risk of increasing the probability of an unnecessary substance penetrating into the inside of the electrode group 44 during a fabrication process but can improve the liquid permeability of a nonaqueous electrolytic solution. In other words, with a reduction in the area of a part of the electrode group 44 provided with each reinforcing element 15 or with a reduction in the thickness of the reinforcing element 15, the liquid permeability of the nonaqueous electrolytic solution into the inside of the electrode group 44 can be increased. On the other hand, with an increase in the area of the part of the electrode group 44 provided with the reinforcing element 15 or with an increase in the thickness of the reinforcing element 15, an unnecessary substance can be prevented from penetrating into the inside of the electrode group 44, and an exposed portion 7 of the positive electrode 8 and an exposed portion 11 of the negative electrode 12 can be reinforced.

The immersion method described in the first embodiment or other embodiments may be used as a method for producing a reinforcing element taking the form shown in FIG. 8. Alternatively, reinforcing elements 15 may be formed before the winding of the positive electrode 8 and the negative electrode 12.

To be specific, after the positive electrode 8 is produced according to the method described in the first embodiment, a solution for reinforcing elements is applied to the exposed portion 7 of the positive electrode 8 using a die coating device or a gravure apparatus and then cooled or dried. Likewise, after the negative electrode 12 is produced according to the method described in the first embodiment, a solution for reinforcing elements is applied to the exposed portion 11 of the negative electrode 12 using a die coating device or a gravure apparatus and then cooled or dried.

Thereafter, the method described in the first embodiment is carried out, thereby fabricating a lithium ion secondary battery.

### Other Embodiments

The above-described embodiments of the present invention may be configured as follows.

Although, in each of the above-described first through fourth embodiments, a positive electrode and a negative electrode are wound with a separator interposed therebetween, positive electrodes and negative electrodes may be stacked with separators interposed therebetween. When positive electrodes and negative electrodes are stacked, a reinforcing element is disposed, at one end of an electrode group, between an exposed portion of the n-th positive electrode 8 and an exposed portion of the (n+1)-th positive electrode, and another reinforcing element is disposed, at the other end of the electrode group, between an exposed portion of the n-th negative electrode and an exposed portion of the (n+1)-th negative electrode.

When a positive electrode and a negative electrode are wound, an electrode group need only form a cylindrical shape or a box shape.

In each of the above-described embodiments, a nonaqueous electrolytic solution is retained at least in a separator. Alternatively, for example, a gel-like nonaqueous electrolyte may be retained at least in a separator. Also when a gel-like nonaqueous electrolyte is retained at least in a separator, the provision of reinforcing elements allows exposed portions of electrodes to be reinforced and can restrain an unnecessary substance from penetrating into the inside of an electrode group.

### EXAMPLES

In each of examples, a lithium ion secondary battery was fabricated, and a short circuit test and the measurement of a direct-current resistance were carried out.

### Example 1

First, a positive electrode was produced.

To be specific, a predetermined proportion of sulfates of Co and Al were added to a NiSO₄ aqueous solution, thereby preparing a saturated aqueous solution. While this saturated aqueous solution was stirred, a sodium hydroxide solution was slowly dropped into this saturated solution. Thus, the saturated solution was neutralized. This allowed a precipitate of tertiary nickel hydroxide Ni_{0.7}CO_{0.2}Al_{0.1}(OH)₂ to be produced (a coprecipitation method). The produced precipitate was filtrated and then rinsed. Then, the rinsed precipitate was dried at 80° C. The average particle size of the resultant nickel hydroxide was approximately 10 μm.

The resultant Ni_{0.7}Co_{0.2}Al_{0.1}(OH)₂ was subjected to heat treatment in the atmosphere at 900° C. for 10 hours, thereby providing nickel oxide Ni_{0.7}CO_{0.2}Al_{0.1}O. Subsequently, the resultant nickel oxide Ni_{0.7}CO_{0.2}Al_{0.1}O was analyzed using a powder X-ray diffraction method, and thus the nickel oxide Ni_{0.7}Co_{0.2}Al_{0.1}O was recognized as a single-phase nickel oxide. Lithium hydroxide 1-hydrate was added to the nickel oxide Ni_{0.7}Co_{0.2}Al_{0.1}O such that the sum of the numbers of Ni atoms, Co atoms and Al atoms becomes equal to the number of Li atoms. The resultant composite was subjected to heat treatment in dry air at 800° C. for 10 hours, thereby providing lithium-nickel composite oxide LiNi_{0.7}Co_{0.2}Al_{0.1}O₂.

When the resultant lithium-nickel composite oxide LiNi_{0.7}Co_{0.2}Al_{0.1}O₂ was analyzed using a powder X-ray diffraction method, the lithium-nickel composite oxide LiNi_{0.7}Co_{0.2}Al_{0.1}O₂ was recognized to have a single-phase hexagonal layered structure. Furthermore, it was recognized that Co and Al were dissolved in the lithium-nickel composite oxide. The lithium-nickel composite oxide was crushed, then classified and powdered. The average particle size of the powders was 9.5 μm. When the specific surface area of the powers was determined according to a BET method, the specific surface area thereof was 0.4 m²/g.

Three kilograms of the resultant lithium-nickel composite oxide, 90 grams of acetylene black and one kilogram of a PVDF solution were kneaded with an appropriate amount of N-methyl-2-pyrrolidone (NMP) in a planetary mixer, thereby preparing a slurry-like positive-electrode mixture. This positive-electrode mixture was applied onto a 20-μm-thick and 150-mm-wide aluminum foil. At this time, one width end of the aluminum foil was formed with a 5-mm-wide uncoated portion. Thereafter, the positive-electrode mixture was dried, and positive-electrode mixture layers were formed on the aluminum foil. The combination of the aluminum foil and the positive-electrode mixture layers was pressed such that the sum of the thicknesses of the positive-electrode mixture layers and the aluminum foil was equal to 100 μm. Thereafter, the pressed combination was cut such that the width of an electrode plate was 105 mm and the width of a mixture-coated portion of the aluminum foil was 100 mm. In this way, a positive electrode of the tabless current-collecting structure shown in FIG. 2 was produced.

Next, a negative electrode was produced.

To be specific, three kilograms of an artificial graphite, 75 grams of an aqueous solution of rubber particles (binder) made of styrene-butadiene copolymer (the weight of the solid content of the aqueous solution was 40 weight %) and 30 grams of carboxymethylcellulose (CMC) were kneaded with an appropriate amount of water in a planetary mixer, thereby preparing a slurry-like negative-electrode mixture. This negative-electrode mixture was applied onto a 10-μm-thick and 150-mm-wide copper foil. At this time, one width end of the copper foil was formed with a 5-mm-wide uncoated portion (exposed portion). Thereafter, the negative-electrode mixture was dried, and negative-electrode mixture layers were formed on the copper foil. The combination of the copper foil and the negative-electrode mixture layers was pressed such that the sum of the thicknesses of the negative-electrode mixture layers and the copper foil was equal to 110 μm. Thereafter, the pressed combination was cut such that the width of an electrode plate was 110 mm and the width of a mixture-coated portion of the copper foil was 105 mm. In this way, a negative electrode of the tabless current-collecting structure shown in FIG. 2 was produced.

A separator made of polyethylene was sandwiched between the produced positive and negative electrodes, and an exposed portion of the positive electrode and an exposed portion of the negative electrode were allowed to extend beyond the end surfaces of the separator along mutually opposite directions. Thereafter, the positive electrode, the negative electrode and the separator were wound, thereby forming a cylindrical shape.

Subsequently, reinforcing elements were formed on the exposed portions.

More specifically, EC serving as a solvent of a nonaqueous electrolytic solution was heated to 50° C. and molten, thereby providing liquid EC. A part of the exposed portion of the positive electrode up to 10 mm from the end surface of the exposed portion was immersed in the liquid EC. Thereafter, the immersed part of the exposed portion was left in a natural state at room temperature so that the liquid EC was solidified. Likewise, a part of the exposed portion of the negative electrode up to 10 mm from the end surface of the exposed portion was immersed in the liquid EC. Thereafter, the immersed part of the exposed portion was left in a natural state at room temperature so that the liquid EC was solidified. In this way, the exposed portion of the positive electrode and the exposed portion of the negative electrode were provided with reinforcing elements, thereby forming an electrode group.

Thereafter, a current collecting structure was formed.

More specifically, first, a circular portion of a current collecting plate made of aluminum and taking the form shown in FIGS. 3(a) and 3(b) was pressed against the end surface of the exposed portion of the positive electrode. Then, lasers were laterally and longitudinally applied crosswise to the current collecting plate without being applied to the middle hole in the current collecting plate. This allowed the current collecting plate made of aluminum to be joined to the end surface of the exposed portion of the positive electrode.

Furthermore, a circular portion of a current collecting plate made of nickel and taking the form shown in FIGS. 3(a) and 3(b) was pressed against the end surface of the exposed portion of the negative electrode. Then, lasers were laterally and longitudinally applied crosswise to the current collecting plate without being applied to the middle hole in the current collecting plate. This allowed the current collecting plate made of nickel to be joined to the end surface of the exposed portion of the negative electrode. In the above-mentioned manner, a current collecting structure was formed.

The formed current collecting structure was inserted into a nickel-coated cylindrical case made of iron. Thereafter, a tab portion of the current collecting plate made of nickel was bent and resistance-welded to the bottom of the case. Furthermore, a tab portion of the current collecting plate made of aluminum was laser-welded to a sealing plate, and a nonaqueous electrolytic solution was injected into the case. In this case, the nonaqueous electrolytic solution was prepared by dissolving lithium phosphate hexafluoride (LiPF₆) as a solute at a concentration of 1 mol/dm³ in a mixed solvent in which EC and ethyl methyl carbonate (EMC) had been mixed at the following compounding ratio, i.e., a volume ratio of 1:3. Thereafter, the sealing plate was crimped onto the case so that the case was sealed. Thus, a lithium ion secondary battery having a nominal capacity of 5 Ah was fabricated. This battery is referred to as a battery of type A.

### Example 2

A lithium ion secondary battery was fabricated in the same manner as in Example 1, except that the production method for a negative electrode was changed.

More specifically, a negative-electrode mixture was applied to the entire surface of a copper foil, and the resultant copper foil was cut to have a width of 105 mm. Thereafter, the mixture layer was separated from one longitudinal end of the copper foil, thereby forming a 7-mm-wide exposed portion. A 5-mm-wide lead made of nickel was resistance-welded to the exposed portion. Thus, the negative electrode shown in FIG. 9 was produced. A lithium ion secondary battery was fabricated in the same manner as in Example 1, except that no reinforcing element was formed on the negative electrode side after the winding of the positive and negative electrodes. This battery is referred to as a battery of type B.

### Example 3

A lithium ion secondary battery was fabricated in the same manner as in Example 1, except that the production method for a positive electrode was changed.

More specifically, a positive-electrode mixture was applied to the entire surface of an aluminum foil, and the resultant aluminum foil was cut to have a width of 100 mm. Thereafter, the mixture layer was separated from one longitudinal end of the aluminum foil, thereby forming a 7-mm-wide exposed portion. A 5-mm-wide lead made of aluminum was resistance-welded to the exposed portion. Thus, the positive electrode shown in FIG. 9 was produced. A lithium ion secondary battery was fabricated in the same manner as in Example 1, except that no reinforcing element was formed on the positive electrode side after the winding of the positive and negative electrodes. This battery is referred to as a battery of type C.

### Example 4

A lithium ion secondary battery was fabricated in the same manner as in Example 1, except that the material of reinforcing elements was changed.

More specifically, a PVDF solution dissolved in NMP was prepared. A part of an exposed portion of a positive electrode up to 10 mm from the end surface of the exposed portion was immersed in the PVDF solution and then heated to 80° C., thereby removing NMP. Likewise, a part of an exposed portion of a negative electrode up to 10 mm from the end surface of the exposed portion was immersed in the PVDF solution and then heated to 80° C., thereby removing NMP. The so-fabricated battery is referred to as a battery of type D.

### Example 5

A lithium ion secondary battery was fabricated in the same manner as in Example 2, except that the material of reinforcing elements was changed.

More specifically, PTFE was dispersed in water, thereby preparing a solution. A part of an exposed portion of a positive electrode up to 10 mm from the end surface of the exposed portion was immersed in the solution and then heated to 80° C., thereby removing water. The so-fabricated battery is referred to as a battery of type E.

### Example 6

A lithium ion secondary battery was fabricated in the same manner as in Example 3, except that the material of reinforcing elements was changed.

More specifically, an aqueous solution of rubber particles (SBR, binder) made of a styrene-butadiene copolymer was prepared. A part of an exposed portion of a negative electrode up to 10 mm from the end surface of the exposed portion was immersed in the solution and then heated to 80° C., thereby removing water. The so-fabricated battery is referred to as a battery of type F.

### Example 7

A lithium ion secondary battery was fabricated in the same manner as in Example 1, except that the material of reinforcing elements was changed.

1,000 grams of alumina whose average particle size is 0.3 μm and 375 grams of polyacrylonitrile-modified rubber (binder) (having a solid content of 8 weight %) were kneaded with an appropriate amount of an NMP solvent in a planetary mixer, thereby producing a slurry-like porous material.

A part of an exposed portion of a positive electrode up to 10 mm from the end surface of the exposed portion was immersed in the slurry-like porous material and then heated to 80° C., thereby removing the NMP solvent. Furthermore, a part of an exposed portion of a negative electrode up to 10 mm from the end surface of the exposed portion was immersed in the slurry-like porous material and then heated to 80° C., thereby removing the NMP solvent. The so-fabricated battery is referred to as a battery of type G.

### Example 8

A lithium ion secondary battery was fabricated in the same manner as in Example 7, except that a lead-type negative electrode as described in Example 2 and a porous-film slurry as described in Example 7 were used and no reinforcing element was formed on the negative electrode side after the winding of a positive electrode and the negative electrode. This battery is referred to as a battery of type H.

### Example 9

A lithium ion secondary battery was fabricated in the same manner as in Example 7, except that a lead-type positive electrode plate as described in Example 3 and a porous-film slurry as described in Example 7 were used and no reinforcing element was formed on the positive electrode side after the winding of positive and negative electrodes. This battery is referred to as a battery of type I.

### Example 10

A lithium ion secondary battery was fabricated according to the method described in Example 1 except for the production method for positive and negative electrodes.

More specifically, liquid EC heated to 50° C. was applied to both surfaces of an exposed portion of a positive electrode and both surfaces of an exposed portion of a negative electrode. At this time, the liquid EC was not applied to parts of the exposed portions of the positive and negative electrodes up to 1 mm from the ends of the exposed portions. Then, the exposed portions of the positive and negative electrodes were cooled. Thereafter, the thickness of a reinforcing element for the positive electrode is allowed to be generally identical with the thickness of a positive-electrode mixture layer, i.e., 40 μm. The thickness of a reinforcing element for the negative electrode is allowed to be generally identical with the thickness of a negative-electrode mixture layer, i.e., 50 μm. A lithium ion secondary battery was fabricated in the same manner as in Example 1, except that no reinforcing element was formed after the winding of the positive and negative electrodes. This battery is referred to as a battery of type J.

### Example 11

A lithium ion secondary battery was fabricated according to the method described in Example 4 except for the production method for positive and negative electrodes.

More specifically, a PVDF solution dissolved in NMP was applied to both surfaces of an exposed portion of a positive electrode and both surfaces of an exposed portion of a negative electrode. At this time, the PVDF solution was not applied to parts of the exposed portions of the positive and negative electrodes up to 1 mm from the ends of the exposed portions. Then, the exposed portions of the positive and negative electrodes were dried to remove NMP. Thereafter, the thickness of a reinforcing element for the positive electrode is allowed to be generally identical with the thickness of a positive-electrode mixture layer, i.e., 40 μm. The thickness of a reinforcing element for the negative electrode is allowed to be generally identical with the thickness of a negative-electrode mixture layer, i.e., 50 μm. A lithium ion secondary battery was fabricated in the same manner as in Example 4, except that no reinforcing element was formed after the winding of the positive and negative electrodes. This battery is referred to as a battery of type K.

### Example 12

A lithium ion secondary battery was fabricated according to the method described in Example 7 except for the production method for positive and negative electrodes.

More specifically, a slurry-like porous material using NMP as a solvent was applied to both surfaces of an exposed portion of a positive electrode and both surfaces of an exposed portion of a negative electrode. At this time, the slurry-like porous material was not applied to parts of the exposed portions of the positive and negative electrodes up to 1 mm from the ends of the exposed portions. Then, the exposed portions of the positive and negative electrodes were dried to remove NMP. Thereafter, the thickness of a reinforcing element for the positive electrode is allowed to be generally identical with the thickness of a positive-electrode mixture layer, i.e., 40 μm. The thickness of a reinforcing element for the negative electrode is allowed to be generally identical with the thickness of a negative-electrode mixture layer, i.e., 50 μm. A lithium ion secondary battery was fabricated in the same manner as in Example 4, except that no reinforcing element was formed after the winding of the positive and negative electrodes. This battery is referred to as a battery of type L.

### Comparative Example 1

A lithium ion secondary battery was fabricated in the same manner as in Example 1, except that a negative electrode as described in Example 2 and a positive electrode as described in Example 3 were used and no reinforcing element was formed after the winding of the positive and negative electrodes. This battery is referred to as a battery of type M.

### Comparative Example 2

No reinforcing element was formed. Furthermore, the current collecting plate shown in FIGS. 4(a) and 4(b) was used as a current collecting plate for a positive electrode, and this current collecting plate was pressed against the end surface of an exposed portion of the positive electrode so as to be joined thereto. Otherwise, a lithium ion secondary battery was fabricated in the same manner as in Example 1. This battery is referred to as a battery of type N.

20 batteries of each of the above-mentioned examples were fabricated. Each of the resultant batteries was evaluated in the following manner.

(Short-Circuit Test)

A current collecting plate was welded to each of electrode groups, and then a voltage of 250 V was applied between a positive-electrode terminal and a negative-electrode terminal. The presence or absence of leakage current after the voltage application was examined. Thus, the presence or absence of a short circuit in the electrode group was examined. For an electrode group of Comparative Example 1, this test was executed after the winding of electrode plates.

(Test for Measurement of Direct-Current Internal Resistance)

Electrode groups that were not recognized as anomalies by the above-described short-circuit test were assembled into batteries. Thereafter, three cycles of charge and discharge of each of the batteries were carried out in a temperature of 25° C. at a current value of 1 A within a voltage range of 3 through 4.2 V, and thus the capacity of the battery was examined. Thereafter, the battery was charged at a constant current in a temperature of 25° C. such that its charging rate reached 60%. Then, charge and discharge pulses were applied to the battery at various constant currents within a range of 5 through 50 A for 10 seconds. The voltage at the tenth second after the application of each pulse was measured, and the measured voltage was plotted against the associated current value. Furthermore, the collinear approximation of voltage plots after the application of discharge pulses was executed using a least square method, and the resultant gradient value was determined as the direct current internal resistance (DCIR). With a reduction in this DCIR, higher power can be obtained during a fixed period.

Table 1 shows the structures of the batteries of the above-described examples and the evaluation results of the batteries. The average value of DCIRs in each example is shown in “DCIR” in Table 1. For the battery capacity, it was recognized that any battery had a nominal capacity of around 5 Ah. Furthermore, it was recognized that the weld strength between any current collecting plate and the associated electrode group was high enough.

TABLE 1

| | | | Location at which | | | | |
|---|---|---|---|---|---|---|---|
| | | | reinforcing element | | | | |
| | | Material of | is formed | | Number | | |
| | Battery | Reinforcing | Positive | Negative | of short | Battery | |
| | Type | element | electrode | electrode | circuits | DCIR | |
| Example 1 | A | EC | ∘ | ∘ | 1 | 6.3 | mΩ |
| Example 2 | B | EC | ∘ | (lead) | None | 8.7 | mΩ |
| Example 3 | C | EC | (lead) | ∘ | None | 8.5 | mΩ |
| Example 4 | D | PVDF | ∘ | ∘ | 1 | 6.6 | mΩ |
| Example 5 | E | PTFE | ∘ | (lead) | 1 | 8.5 | mΩ |
| Example 6 | F | SBR | (lead) | ∘ | None | 8.3 | mΩ |
| Example 7 | G | Porous film | ∘ | ∘ | None | 6.4 | mΩ |
| Example 8 | H | Porous film | ∘ | (lead) | 1 | 8.5 | mΩ |
| Example 9 | I | Porous film | (lead) | ∘ | 1 | 8.7 | mΩ |
| Example 10 | J | EC | ∘ | ∘ | 2 | 6.4 | mΩ |
| Example 11 | K | PVDF | ∘ | ∘ | 1 | 6.5 | mΩ |
| Example 12 | L | Porous film | ∘ | ∘ | None | 6.5 | mΩ |
| Comparative | M | (lead) | (lead) | (lead) | 1 | 10.9 | mΩ |
| example 1 | | | | | | | |
| Comparative | N | (none, tabless) | None | None | 5 | 6.2 | mΩ |
| example 2 | | | | | | | |

The results in Table 1 will be considered.

First, the number of short circuits in electrode groups will be considered.

For the batteries of type N which each have a tabless current-collecting structure and are provided without any reinforcing element, electrode groups of five of the examined 20 lithium ion secondary batteries were short-circuited. After each of the short-circuited electrode groups was disassembled and then observed, it was recognized that a hole was formed in a separator. It was estimated that this hole was formed as a result of spatters entering into the inside of the separator in the laser welding of a current collecting plate to one end surface of the electrode group. Furthermore, after the surroundings of a part of a current collector welded to the current collecting plate were observed, kinks in an associated exposed portion or the buckling of the exposed portion were recognized. It has been estimated that the kinks in the exposed portion or the buckling of the exposed portion were caused by pressing the current collecting plate against the electrode group. It has been considered that these factors caused a lot of short circuits.

On the other hand, the number of short circuits in the batteries of each of types A through I and M was reduced as compared with that in the batteries of type N. After electrode groups of short-circuited ones of the batteries of types A through I and M were disassembled and then observed, the buckling of an exposed portion of each electrode group and any hole in a separator thereof was not able to be recognized. In view of these results, it is considered that the provision of reinforcing elements allowed the exposed portion to be reinforced and allowed spatters or the like to be restrained from scattering into the inside of the electrode group. It is estimated that the reason why a short circuit was recognized would be a physical reason, e.g., due to the mixing of foreign particles into the inside of the electrode group. The reason for this is that a black spot was recognized on the surface of the separator inside the electrode group.

The number of short circuits in the batteries of each of types J through L was also reduced as compared with that in the batteries of type N. After electrode groups of short-circuited ones of the batteries of types J through L were disassembled and then observed, the degree of buckling of an exposed portion of each electrode group was small as compared with the batteries of type N. The reason for this is considered that since reinforcing elements are formed around the exposed portions, this allowed the exposed portions to be reinforced as compared with a case where no reinforcing element is formed. A hole formed due to spatters produced in the laser welding of a current collecting plate was recognized in a part of a separator. While it was estimated that a hole in a part of the separator interposed between a positive electrode and a negative electrode caused a short circuit, it was estimated that a hole in a part of the separator in contact with the reinforcing elements could prevent a short circuit.

In view of the above-described results, it is estimated that since the provision of reinforcing elements allowed the reinforcement of exposed portions, this permitted a reduction in the degree of buckling of the exposed portions. When a hole was formed in a part of a separator interposed between a positive electrode and a negative electrode, this made it difficult to prevent the occurrence of a short circuit. Meanwhile, when a hole was formed in a part of the separator in contact with the reinforcing elements, this made it possible to restrain the occurrence of a short circuit. In view of the above, it is estimated that the provision of the reinforcing elements allowed the occurrence of a short circuit to be suppressed.

Next, the results of DCIR will be considered.

The DCIR of a battery of type M that collects current through a current collecting lead was 10.9 mΩ which was larger than that of a battery of each of the other types. On the other hand, the DCIR of the battery of each of types A, D, G, J through L and N having a tabless current-collecting structure was 6.2 through 6.6 mΩ and allowed to be reduced approximately 40% as compared with that of the battery of type M. The reason for this is that the use of the tabless current-collecting structure permitted a reduction in the current collection resistance. The DCIR of the battery of each of types B, C, E, F, H, and I in which any one of a positive electrode and a negative electrode has a tabless current-collecting structure was also allowed to be reduced approximately 20% as compared with that of the battery of type M.

The above-described results show that the batteries of types A through L were allowed to restrain an internal short circuit from being caused in welding as compared with the battery of type N and reduce their DCIRs as compared with the DCIR of the battery of type M. In view of the above, the batteries of types A through L were allowed to restrain an internal short circuit caused in the fabrication of the batteries, reduce their resistances and thus obtain high power.

### INDUSTRIAL APPLICABILITY

The present invention is very useful in the field of lithium ion secondary batteries requiring high-rate characteristics. A lithium ion secondary battery of the present invention is useful as a driving power supply for a notebook computer, a mobile phone, a digital still camera, a power tool, an electric motor vehicle, or any other device.

1. (canceled)

2. A nonaqueous electrolyte secondary battery comprising an electrode group in which a positive electrode and a negative electrode are wound or stacked with a separator interposed therebetween; a nonaqueous electrolyte retained in the separator; and a current collecting plate joined to the electrode group,
wherein one width end of one of the positive and negative electrodes is provided with an exposed portion in which a current collector is exposed from a mixture layer,
in the electrode group, the exposed portion extends beyond an associated end surface of the separator and an associated end surface of the other electrode along the width of each said electrode, and the current collecting plate is joined to the end surface of the exposed portion, and
a reinforcing element for reinforcing the exposed portion is formed between adjacent parts of the exposed portion, and
the reinforcing element covers an associated end surface of the mixture layer of said one electrode, the associated end surface of the separator and the associated end surface of the other electrode.

3. The nonaqueous electrolyte secondary battery of claim 2, wherein
a part of the reinforcing element covering the associated end surface of the other electrode is thinner than a part of the reinforcing element covering the associated end surface of the mixture layer of said one electrode.

4. A nonaqueous electrolyte secondary comprising an electrode group in which a positive electrode and a negative electrode are wound or stacked with a separator interposed therebetween; a nonaqueous electrolyte retained in the separator; and a current collecting plate joined to the electrode group,
wherein one end of one of the positive and negative electrodes in the width direction of said one electrode is provided with an exposed portion in which a current collector is exposed from a mixture layer,
in the electrode group, the exposed portion extends beyond an associated end surface of the separator and an associated end surface of the other electrode along the width of each said electrode, and the current collecting plate is joined to the end surface of the exposed portion,
a reinforcing element for reinforcing the exposed portion is formed between adjacent parts of the exposed portion,
the associated end surface of the mixture layer of said one electrode is covered with the reinforcing element, and
the associated end surface of the separator and the associated end surface of the other electrode are exposed from the reinforcing element.

5. The nonaqueous electrolyte secondary battery of claim 2, wherein
the reinforcing element is porous.

6. The nonaqueous electrolyte secondary battery of claim 5, wherein
the reinforcing element is a binder.

7. The nonaqueous electrolyte secondary battery of claim 2, wherein
the nonaqueous electrolyte contains a nonaqueous solvent and a solute, and
the reinforcing element contains the solidified nonaqueous solvent.

8. The nonaqueous electrolyte secondary battery of claim 7, wherein
the reinforcing element is made of ethylene carbonate.

9. The nonaqueous electrolyte secondary battery of claim 4, wherein
the reinforcing element is porous.

10. The nonaqueous electrolyte secondary battery of claim 4, wherein
the nonaqueous electrolyte contains a nonaqueous solvent and a solute, and
the reinforcing element contains the solidified nonaqueous solvent.
